(19) United States
(12) Patent Application Publication
(10) Pub. No.: US 2012/0238711 A1
(43) Pub. Date: Sep. 20, 2012

(54) EPOXY RESIN COMPOSITIONS

(76) Inventor: Maurice J. Marks, Lake Jackson, TX (US)

(21) Appl. No.: 13/510,316

(22) PCT Filed: Dec. 2, 2010
(86) PCT No.: PCT/US10/58695

§ 371 Date: May 17, 2012

Related U.S. Application Data
(60) Provisional application No. 61/267,947, filed on Dec. 9, 2009.

(51) Int. Cl. C08L 63/00

(52) U.S. Cl. 525/526; 525/524; 525/527

(57) ABSTRACT

An epoxy resin composition including a divinylarene dioxide, for example a divinylbenzene dioxide, wherein the divinylarene dioxide has an impurity concentration of less than about 15 weight percent styrenic impurities such as ethylstyrene. Such prepared divinylarene dioxides may be used to prepare curable epoxy resin compositions or formulations, including a blend of a divinylarene dioxide and at least another epoxy resin different from the divinylarene dioxide; and a curable epoxy resin composition including (i) the blend of epoxy resins of the divinylarene dioxide and the at least one epoxy resin different from the divinylarene dioxide; (ii) at least one curing agent; and (iii) optionally, at least one catalyst. The significantly lower concentration of styrenic impurities in the divinylarene dioxides of the present invention provides an epoxy resin composition having low viscosity, better storage stability, and better thermal stability.

### BACKGROUND OF THE INVENTION

1. Field of the Invention

The present invention is related to epoxy resin compositions; and more specifically to low viscosity liquid epoxy resin compositions and thermosets derived therefrom, particularly wherein the epoxy resin compositions are based on divinylarene dioxides having an impurity concentration of less than about 15 weight percent (wt %) of styrenic impurities; and a process for preparing said compositions.

2. Description of Background and Related Art

Aliphatic and mono-aromatic resins have low viscosity while most polyfunctional aromatic glycidyl ether epoxy resins are relatively viscous liquids (e.g. having a viscosity of greater than 1000 mPa-s at 25° C.) which often require the use of diluents to lower the viscosity of such epoxy resins (e.g. to less than about 500 mPa-s) in order to process the epoxy resins in thermoset applications.

U.S. Pat. No. 2,982,752 (“the '752 patent”) describes epoxy resin compositions comprising a mixture of an aromatic glycidyl ether and divinylbenzene dioxide (DVBDO). The '752 patent discloses that the viscosity of a polyglycidyl polyether of a polyhydric phenol can be effectively reduced to fit specific applications by incorporating therewith an amount of DVBDO, and the resulting mixture upon curing exhibits improved physical properties. The '752 patent also teaches that the DVBDO, used in the process of the '752 patent to prepare the epoxy resin compositions, is prepared using peracetic acid. The '752 patent further discloses that the DVBDO is at most 83% pure. The impurity in the DVBDO of the '752 patent is identified as ethylstyrene.

It would be desirable to provide a DVBDO and other divinylarene dioxides having a lower concentration of impurities such as ethylstyrene in order to prepare purer DVBDO resins which can, in turn, be used to prepare epoxy resin mixtures having low viscosity, better thermal stability and better crystallization resistance; and derived thermosets therefrom having improved thermal integrity, and other beneficial properties required for use in thermoset applications, while maintaining the same thermal and mechanical properties of the epoxy resin product.

### SUMMARY OF THE INVENTION

One embodiment of the present invention is directed to a composition comprising a divinylarene dioxide, for example a DVBDO. In the present invention, the divinylarene dioxide such as DVBDO is prepared by reacting a divinylarene and hydrogen peroxide to provide the divinylarene dioxide useful in epoxy resin compositions of the present invention. The resulting divinylarene dioxide product contains less than about 15 weight percent (wt %) styrenic impurities such as ethylstyrene. Such prepared divinylarene dioxide may be used as a substitute for a conventional epoxy resin component typically used to produce an epoxy resin composition or formulation. The significantly lower concentration of styrenic impurities in the divinylarene dioxides of the present invention provides an epoxy resin composition having low viscosity and better thermal stability.

Another embodiment of the present invention is directed to thermosets derived from the above epoxy resin composition having lower impurities; wherein the resulting thermosets have significantly improved thermal integrity.

In one embodiment, a curable epoxy resin thermoset formulation based on the divinylarene dioxide may be cured to form a thermoset. The resulting curable thermoset formulation may be used in various applications, such as for example, coatings, adhesives, composites, electronics, and the like.

Yet another embodiment of the present invention is directed to an epoxy resin composition which comprises a mixture of: (a) a divinylarene dioxide as a first comonomer, for example a DVBDO having lower impurities; and (b) at least one epoxy resin, as a second comonomer, for example a diglycidyl ether of bisphenol A. Mixtures of epoxy resins with divinylarene dioxides, prepared from divinylarenes and hydrogen peroxide or other oxidants, also have significantly low viscosity and good crystallization resistance prior to curing; and better thermal integretity and high heat resistance after curing.

Still another embodiment of the present invention is directed to a process for preparing the epoxy resin composition having lower impurities described above.

### DETAILED DESCRIPTION OF THE INVENTION

In its broadest scope, the present invention includes an epoxy resin composition wherein the epoxy component of the composition comprises a divinylarene dioxide of the present invention, alone, or in combination with other epoxy resins which are typically used to produce an epoxy resin composition or formulation. The resulting divinylarene dioxide product of the present invention contains less than about 15% styrenic impurities.

“Styrenic impurities” herein means any one or more undesirable compounds present in combination with divinylarene dioxide which is not a divinylarene dioxide including for example styrene and/or ethyl styrene. Such styrenic impurities do not polymerize with epoxy resin curing catalysts or co-reactive curing agents; and are more volatile than divinylarene dioxides.

“Crystallization resistance” herein means the time in days for a liquid epoxy resin or mixtures thereof to cease its ability to flow due to formation of solids according to an industry standard test as described below.

“Thermal stability” herein means an epoxy resin or a mixture of epoxy resins which does not produce excessive weight loss when heated to moderate temperatures.

“Thermal integrity” herein means either a formulation which does not phase separate upon standing or a thermoset which does not form voids upon heating to curing temperatures. Thermosets having adequate thermal integrity also show an insignificant decrease in specific gravity upon curing.

The divinylarene dioxides useful in the present invention, particularly those derived from divinylbenzene such as for example DVBDO, are class of diepoxides which have a relatively lower liquid viscosity but a higher rigidity than conventional epoxy resins.

The divinylarene dioxide useful in the present invention may comprise, for example, any substituted or unsubstituted arene nucleus bearing two vinyl groups in any ring position. The arene portion of the divinylarene dioxide may consist of benzene, substituted benzenes, (substituted) ring-annulated benzenes or homologously bonded (substituted) benzenes, or mixtures thereof. The divinylbenzene portion of the divinylarene dioxide may be ortho, meta, or para isomers or any mixture thereof. Additional substituents may consist of H₂O₂-resistant groups including saturated alkyl, aryl, halogen, nitro, isocyanate, or RO— (where R may be a saturated alkyl or aryl). Ring-annulated benzenes may consist of naphthlalene, tetrahydronaphthalene, and the like. Homologously bonded (substituted) benzenes may consist of biphenyl, diphenylether, and the like.

In one embodiment, the divinylarene dioxide used in the present invention may be produced, for example, by the process described in U.S. patent application Ser. No. 61/141,457, filed Dec. 30, 2008 herewith, by Marks et al., incorporated herein by reference.

The divinylarene dioxide used for preparing the composition of the present invention may be illustrated generally by general chemical Structures I-IV as follows:

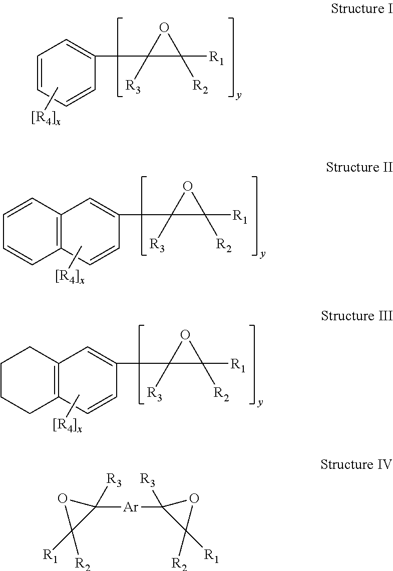

In the above Structures I-IV of the divinylarene dioxide comonomer of the present invention, each R₁, R₂, R₃ and R₄ individually may be hydrogen, an alkyl, cycloalkyl, an aryl or an aralkyl group; or a H₂O₂-resistant group including for example a halogen, a nitro, an isocyanate, or an RO group, wherein R may be an alkyl, aryl or aralkyl; x may be an interger of 0 to 4; y may be an integer greater than or equal to 2; x+y may be an integer less than or equal to 6; z may be an interger of 0 to 6; z+y may be an integer less than or equal to 8; and Ar is an arene fragment including for example, 1,3-phenylene group.

In another embodiment, the divinylarene dioxide useful in the present invention may comprise, for example, divinylbenzene dioxide, divinylnaphthalene dioxide, divinylbiphenyl dioxide, divinyldiphenylether dioxide, and mixtures thereof.

In a preferred embodiment of the present invention, the divinylarene dioxide used in the epoxy resin formulation may be for example DVBDO. Most preferably, the divinylarene dioxide component that is useful in the present invention includes, for example, a DVBDO as illustrated by the following chemical formula of Structure V:

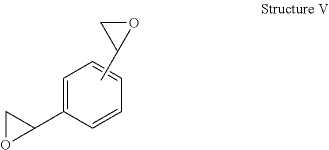

The chemical formula of the above DVBDO compound may be as follows: C₁₀H₁₀O₂; the molecular weight of the DVBDO is about 162.2; and the elemental analysis of the DVBDO is about: C, 74.06; H, 6.21; and O, 19.73 with an epoxide equivalent weight of about 81 g/mol.

Divinylarene dioxides, particularly those derived from divinylbenzene such as for example DVBDO, are class of diepoxides which have a relatively lower liquid viscosity but a higher rigidity and crosslink density than conventional epoxy resins.

Structure VI below illustrates an embodiment of a preferred chemical structure of the DVBDO useful in the present invention:

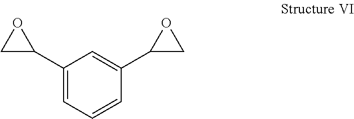

Structure VII below illustrates another embodiment of a preferred chemical structure of the DVBDO useful in the present invention:

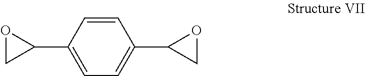

When DVBDO is prepared by the processes known in the art, it is possible to obtain one of three possible isomers: ortho, meta, and para. Accordingly, the present invention includes a DVBDO illustrated by any one of the above Structures individually or as a mixture thereof. Structures VI and VII above show the meta (1,3-DVBDO) isomer of DVBDO and the para (1,4-DVBDO) isomer of DVBDO, respectively. The ortho isomer is rare; and usually DVBDO is mostly produced generally in a range of from about 9:1 to about 1:9 ratio of meta isomer (Structure VI) to para isomer (Structure VII). The present invention preferably includes as one embodiment a range of from about 6:1 to about 1:6 ratio of Structure VI to Structure VII, and in other embodiments the ratio of Structure VI to Structure VII may be from about 4:1 to about 1:4 or from about 2:1 to about 1:2.

In another embodiment of the present invention, the divinylarene dioxide may contain quantities (such as for example less than about 20 weight percent) of substituted arenes. The amount and structure of the substituted arenes depend on the process used in the preparation of the divinylarene precursor to the divinylarene dioxide. For example, divinylbenzene (DVB) prepared by the dehydrogenation of diethylbenzene (DEB) may contain quantities of ethylvinylbenzene (EVB) and DEB. Upon reaction with hydrogen peroxide, EVB produces ethylvinylbenzene monoxide while DEB remains unchanged. The presence of these compounds can increase the epoxide equivalent weight of the divinylarene dioxide to a value greater than that of the pure compound.

In one embodiment, the divinylarene dioxide, for example a DVBDO, useful in the present invention comprises a low viscosity liquid epoxy resin (LER) composition. The viscosity of the divinylarene dioxide used in the process for making the epoxy resin composition of the present invention ranges generally from about 10 mPa-s to about 100 mPa-s, preferably from about 10 mPa-s to about 50 mPa-s, and more preferably from about 10 mPa-s to about 25 mPa-s at 25° C.

One of the advantageous properties of the divinylarene dioxides useful in the present invention is their thermal stability which allows their use in formulations or processing at moderate temperatures (for example, at from about 100° C. to about 200° C.) for up to several hours (for example, for at least 2 hours) without oligomerization or homopolymerization. Oligomerization or homopolymerization during formulation or processing is evident by a substantial increase in viscosity or gelling (crosslinking) The divinylarene dioxides useful in the present invention have sufficient thermal stability such that the divinylarene dioxides do not experience a substantial increase in viscosity or gelling during formulation or processing at moderate temperatures.

Another advantageous property of the divinylarene dioxide useful in the present invention, may be for example its rigidity. The rigidity property of the divinylarene dioxide is measured by a calculated number of rotational degrees of freedom of the dioxide excluding side chains using the method of Bicerano described in Prediction of Polymer Properties, Dekker, New York, 1993. The rigidity of the divinylarene dioxide used in the present invention may range generally from about 6 to about 10, preferably from about 6 to about 9, and more preferably from about 6 to about 8 rotational degrees of freedom.

The divinylarene dioxide product, for example DVBDO, of the present invention may contain undesirable by-products and more specifically styrenic impurities. Generally, the styrenic impurities present in the product may be based on some of the reactant monomers not reacting during the manufacture of the divinylarene dioxide product or based on the reactant monomers reacting to create side by-products. The level of styrenic impurities is usually present in the product in trace amounts. In general, the level of styrenic impurities present in the product of the present invention may be is less than about 15 wt %, preferably less than about 10 wt %, more preferably less than about 5 wt %, most preferably less than about 1 wt %; and even most preferably zero wt %.

In one embodiment, the divinylarene dioxide product will have styrenic impurites at a level of from about 10 ppm to about less than about 15 wt %; in another embodiment the level may be from about 100 ppm to about 5 wt % and in still another embodiment the level may be from about 1 wt % to about 3 wt %.

In another embodiment, the divinylarene dioxide product will have a thermal stability, as measured by its temperature of 5 wt. % loss, of greater than about 83° C., preferably greater than about 85° C., and most preferably greater than about 90° C.

In a broad embodiment of the present invention, an epoxy resin composition may be prepared comprising a mixture of: (a) a divinylarene dioxide as a first comonomer, for example a DVBDO; and (b) at least one epoxy resin that is different from the divinylarene dioxide of component (a), as a second comonomer, for example a diglycidyl ether of bisphenol A. Mixtures of epoxy resins with divinylarene dioxides, prepared from divinylarenes and hydrogen peroxide or other oxidants, also have significantly low viscosity, improved crystallization resistance, and higher thermal stability before curing; and better thermal integrity and high heat resistance after curing.

The viscosity of the epoxy resin composition of the present invention ranges generally from about 5 mPa-s to about 5000 mPa-s; preferably, from about 5 mPa-s to about 1000 mPa-s; and more preferably, from about 10 mPa-s to about 500 mPa-s at 25° C.

The crystallization resistance of the epoxy resin composition of the present invention as determined by ISO 4895 generally may be greater than 8 days, preferably greater than 10 days, and most preferably greater than 50 days.

The first component (a), of the epoxy resin composition comprising a blend of epoxies, may be the divinylarene dioxide described above.

The concentration of the divinylarene dioxide used in the epoxy resin mixture of the present invention may range generally from about 99 weight percent (wt %) to about 1 wt %; preferably, from about 95 wt % to about 5 wt %; and more preferably, from about 90 wt % to about 10 wt %. In some epoxy resin compositions, such as DER 383 with a greater than 15 wt % DVBDO results in a very long term crystallization resistance as illustrated below in the Examples.

In preparing the epoxy resin composition blend or mixture of the present invention, in addition to the divinylarene dioxide described above, the mixture may include at least one epoxy resin, component (b), different than the divinylarene dioxide, component (a), described above. Epoxy resins are those compounds containing at least one vicinal epoxy group. The epoxy resin may be saturated or unsaturated, aliphatic, cycloaliphatic, aromatic or heterocyclic and may be substituted. The epoxy resin may also be monomeric or polymeric. The epoxy resin useful in the present invention may be selected from any known epoxy resins in the art. An extensive enumeration of epoxy resins useful in the present invention is found in Lee, H. and Neville, K., “Handbook of Epoxy Resins,” McGraw-Hill Book Company, New York, 1967, Chapter 2, pages 257-307; incorporated herein by reference.

The epoxy resin, used in embodiments disclosed herein for component (b) of the present invention, may vary and include conventional and commercially available epoxy resins, which may be used individually or in combinations of two or more. In choosing epoxy resins for compositions disclosed herein, consideration should not only be given to properties of the final product, but also to viscosity and other properties that may influence the processing of the resin composition.

Particularly suitable epoxy resins known to the skilled worker are based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy resins known to the skilled worker include reaction products of epichlorohydrin with o-cresol and, respectively, phenol novolacs. It is also possible to use a mixture of two or more epoxy resins.

The epoxy resin, component (b), useful in the present invention for the preparation of the epoxy resin composition, may be selected from commercially available products. For example, D.E.R. 331®, D.E.R.332, D.E.R. 334, D.E.R. 580, D.E.N. 431, D.E.N. 438, D.E.R. 736, or D.E.R. 732 epoxy resins available from The Dow Chemical Company may be used. As an illustration of the present invention, the epoxy resin component (a) may be a liquid epoxy resin, D.E.R. 383 epoxy resin having an epoxide equivalent weight of 175-185, a viscosity of 9.5 Pa-s, and a density of 1.16 gms/cc. Other commercial epoxy resins that can be used for the epoxy resin component can be D.E.R. 330, D.E.R. 354, or D.E.R. 332 epoxy resins. D.E.R. is a trademark of The Dow Chemical Company.

Other suitable epoxy resins useful as component (b) are disclosed in, for example, U.S. Pat. Nos. 3,018,262.7,163,973, 6,887,574, 6,632,893, 6,242,083, 7,037,958, 6,572,971, 6,153,719, and 5,405,688, PCT Publication WO 2006/052727; U.S. Patent Application Publication Nos. 20060293172, 20050171237, 2007/0221890 A1; each of which is hereby incorporated herein by reference.

In a preferred embodiment, the epoxy resin useful in the composition of the present invention comprises any aromatic or aliphatic glycidyl ether or glycidyl amine or a cycloaliphatic epoxy resin.

In general, the choice of the epoxy resin used in the present invention depends on the application. However, diglycidyl ether of bisphenol A and derivatives thereof are particularly preferred. Other epoxy resins can be selected from, but limited to, for example: bisphenol F epoxy resins, novolac epoxy resins, glycidylamine-based epoxy resins, alicyclic epoxy resins, linear aliphatic epoxy resins, tetrabromobisphenol A epoxy resins, and combinations thereof.

The at least one epoxy resin, component (b), may be present in the epoxy resin mixture composition at a concentration ranging generally from about 1 wt % to about 99 wt %, preferably from about 5 wt % to about 95 wt %, and more preferably from about 10 wt % to about 90 wt %.

In another broad embodiment of the present invention, a curable epoxy resin composition may comprise a reaction mixture of (i) the epoxy blend of the divinylarene dioxide and the at least one epoxy resin other than the divinylarene dioxide, as described above; and (ii) at least one curing agent; and (iii) optionally, at least one catalyst.

Component (i) of the curable epoxy resin composition comprises the epoxy resin composition described above which may be prepared by mixing: (a) a divinylarene dioxide as a first co-monomer; and (b) at least one epoxy resin that is different from the divinylarene dioxide of component (a), as a second co-monomer.

The amount of the epoxy resin blend used in the curable epoxy resin composition generally ranges from about 99 wt % to about 1 wt %, preferably from about 95 wt % to about 5 wt %, and more preferably from about 90 wt % to about 10 wt %. Above and below the aforementioned ranges, the curing of the composition does not sufficiently occur.

The curing agent, component (ii), useful for the curable epoxy resin composition of the present invention, may comprise any conventional curing agent known in the art for curing epoxy resins. The curing agents, (also referred to as a hardener or cross-linking agent) useful in the thermosettable composition, may be selected, for example, from those curing agents well known in the art including, but are not limited to, anhydrides, carboxylic acids, amine compounds, or mixtures thereof.

Examples of the optional curing agent useful in the present invention may include any of the curing materials known to be useful for curing epoxy resin based compositions. Such materials include, for example, co-reactive curing agents such as polyamine, polyamide, polyaminoamide, dicyandiamide, polycarboxylic acid and anhydride, and catalytic curing agents such as tertiary amine, quaternary ammonium halide, and any combination thereof or the like. Other specific examples of the curing agent include styrene-maleic acid anhydride (SMA) copolymers; and any combination thereof. Among the conventional epoxy curing agents, amines and amino or amido containing resins and anhydrides are preferred.

Dicyandiamide may be one preferred embodiment of the curing agent useful in the present invention. Dicyandiamide has the advantage of providing delayed curing, that is, since dicyandiamide requires relatively high temperatures for activating its curing properties, dicyandiamide can be added to an epoxy resin and stored at room temperature (about 25° C.).

The amount of the curing agent used in the curable epoxy resin composition generally ranges from about 1 wt % to about 99 wt %, preferably from about 5 wt % to about 95 wt %, and more preferably from about 10 wt % to about 90 wt %. Above and below the aforementioned ranges, the curing of the composition does not sufficiently occur.

An assortment of additives may be optionally added to the compositions of the present invention including for example, catalysts, solvents, other resins, stabilizers, fillers, plasticizers, catalyst de-activators, and mixtures thereof.

For example, in preparing the curable epoxy resin compositions of the present invention, at least one curing catalyst, component (iii), may optionally be used. The curing catalyst used in the present invention may be adapted for polymerization, including homopolymerization, of the at least one epoxy resin. Alternatively, curing catalyst used in the present invention may be adapted for a reaction between the at least one epoxy resin and the at least one curing agent, if used.

The optional curing catalyst, component (iii), useful in the present invention may include catalysts well known in the art, such as for example, catalyst compounds containing amine, phosphine, heterocyclic nitrogen, ammonium, phosphonium, arsonium, sulfonium moieties, and any combination thereof. Some non-limiting examples of the catalyst of the present invention may include, for example, ethyltriphenylphosphonium acetate; benzyltrimethylammonium chloride; heterocyclic nitrogen-containing catalysts described in U.S. Pat. No. 4,925,901, incorporated herein by reference; imidazoles; triethylamine; and any combination thereof.

The selection of the curing catalyst useful in the present invention is not limited and commonly used catalysts for epoxy systems can be used. Also, the addition of a catalyst is optional and depends on the system prepared. When the catalyst is used, preferred examples of catalyst include tertiary amines, imidazoles, organo-phosphines, and acid salts.

Most preferred catalysts used in the present invention include tertiary amines such as, for example, triethylamine, tripropylamine, tributylamine, 2-methylimidazole, benzyldimethylamine, mixtures thereof and the like.

The concentration of the optional catalyst used in the present invention may range generally from 0 wt % to about 20 wt %, preferably from about 0.01 wt % to about 10 wt %, more preferably from about 0.1 wt % to about 5 wt %, and most preferably from about 0.2 wt % to about 2 wt %. Above and below the aforementioned ranges, there is no significant effect or there may be some deterioration of the resin properties.

In still another embodiment of the present invention, one or more optional organic solvents well known in the art may be used in the curable epoxy resin composition. For example, aromatics such as xylene, ketones such as methyl ether ketone, and alcohols such as 1-methoxy-2-propanol; and mixtures thereof, may be used in the present invention.

The concentration of the optional solvent used in the present invention may range generally from 0 wt % to about 90 wt %, preferably from about 0.01 wt % to about 80 wt %, more preferably from about 1 wt % to about 70 wt %, and most preferably from about 10 wt % to about 60 wt %.

The curable or thermosettable composition of the present invention may optionally contain one or more other additives which are useful for their intended uses. For example, the optional additives useful in the present invention composition may include, but not limited to, stabilizers, surfactants, flow modifiers, pigments or dyes, matting agents, degassing agents, flame retardants (e.g., inorganic flame retardants, halogenated flame retardants, and non-halogenated flame retardants such as phosphorus-containing materials), toughening agents, curing initiators, curing inhibitors, wetting agents, colorants or pigments, thermoplastics, processing aids, UV blocking compounds, fluorescent compounds, UV stabilizers, inert fillers, fibrous reinforcements, antioxidants, impact modifiers including thermoplastic particles, and mixtures thereof. The above list is intended to be exemplary and not limiting. The preferred additives for the, formulation of the present invention may be optimized by the skilled artisan.

The concentration of the additional additives is generally between about 0 wt % to about 90 wt %; preferably, between about 0.01 wt % to about 80 wt %; more preferably, between about 1 wt % to about 65 wt %; and most preferably, between about 10 wt % to about 50 wt % based on the weight of the total composition. Above and below the aforementioned ranges, there is no significant effect or there may be some deterioration of the resin properties.

The preparation of the composition of the present invention is achieved by admixing in a vessel the following components: a divinylarene dioxide, a curing agent, optionally an epoxy resin, optionally a catalyst, optionally an inert organic solvent, and optionally other additives; and then allowing the components to formulate into a liquid epoxy resin composition. There is no criticality to the order of mixture, i.e., the components of the formulation or composition of the present invention may be admixed in any order to provide the thermosettable composition of the present invention. Any of the above-mentioned optional assorted formulation additives, for example fillers, may also be added to the composition during the mixing or prior to the mixing to form the composition.

All the components of the curable divinylarene dioxide resin composition are typically mixed and dispersed at a temperature enabling the preparation of an effective curable divinylarene dioxide resin composition having a low viscosity for the desired application. The temperature during the mixing of all components may be generally from about 0° C. to about 100° C. and preferably from about 20° C. to about 50° C.

The curable epoxy resin formulation or composition of the present invention can be cured under conventional processing conditions to form a thermoset. The resulting thermoset displays excellent thermo-mechanical properties, such as good toughness and mechanical strength, while maintaining high thermal stability, as illustrated below in the Examples.

The process to produce the thermoset products of the present invention may be performed by gravity casting, vacuum casting, automatic pressure gelation (APG), vacuum pressure gelation (VPG), infusion, filament winding, lay up injection, transfer molding, prepreging, dipping, coating, spraying, brushing, and the like.

The curing reaction conditions include, for example, carrying out the reaction under a temperature, generally in the range of from about 0° C. to about 300° C.; preferably, from about 20° C. to about 250° C.; and more preferably, from about 50° C. to about 200° C.

The pressure of the curing reaction may be carried out, for example, at a pressure of from about 0.01 bar to about 1000 bar; preferably, from about 0.1 bar to about bar 100; and more preferably, from about 0.5 bar to about 10 bar.

The curing of the curable or thermosettable composition may be carried out, for example, for a predetermined period of time sufficient to cure the composition. For example, the curing time may be chosen between about 1 minute to about 24 hours, preferably between about 10 minutes to about 12 hours, and more preferably between about 100 minutes to about 8 hours.

The curing process of the present invention may be a batch or a continuous process. The reactor used in the process may be any reactor and ancillary equipment well known to those skilled in the art.

The thermal integrity of the cured or thermoset product prepared by curing the epoxy resin of the present invention advantageously exhibits no appearance of phase separation of the ethyl styrenic impurities or voids formed by evaporation of the ethyl stryrenic impurities. In one embodiment, the compositions of the present invention may produce thermosets having less than about 2.2% lower specific gravity as measured by ASTM D792 compared to a corresponding composition having less than about 10 ppm ethyl styrenic impurities.

The compositions of the present invention are useful for the preparation of epoxy thermosets or cured products in the form of coatings, films, adhesives, laminates, composites, electronics, and the like.

As an illustration of the present invention, in general, the epoxy resin compositions may be useful for casting, potting, encapsulation, molding, and tooling. The present invention is particularly suitable for all types of electrical casting, potting, and encapsulation applications; for molding and plastic tooling; and for the fabrication of epoxy based composites parts, particularly for producing large epoxy-based parts produced by casting, potting and encapsulation. The resulting composite material may be useful in some applications, such as electrical casting applications or electronic encapsulations, castings, moldings, potting, encapsulations, injection, resin transfer moldings, composites, coatings and the like.

### Examples

The following examples and comparative examples further illustrate the present invention in detail but are not to be construed to limit the scope thereof.

Various terms and designations used in the following examples are explained herein as follows: “DVBDO” stands for divinylbenzene dioxide; “EVBO” stands for ethylvinylbenzene oxide; “DVBDO-95” stands for a mixture of about 95 wt. % DVBDO and about 5 wt. % EVBO; “DVBDO-80” stands for a mixture of about 80 wt. % DVBDO and about 20 wt. % EVBO; “ES” stands for ethyl styrene; “TGA” stands for thermal gravimetric analysis; D.E.R. 383 epoxy resin is an epoxy resin commercially available from The Dow Chemical Company having an EEW of 176-183 g/eq; and D.E.H. 20 epoxy hardener is a technical grade of diethylenetriamine commercially available from The Dow Chemical Company having an amine hydrogen equivalent weight of about 21.

The following standard analytical equipments and methods are used in the Examples herein are as follows: Viscosity is measured using an ARES rheometer at a frequency of 10 s⁻¹ at 30° C.; crystallization resistance is measured according to ISO 4985; specific gravity is measured according to ASTM D792; and thermal stability is measured as the temperature in ° C. at which the sample has lost 5 wt % (T₋₅) by TGA under nitrogen using a heating rate of 10° C./minute on a TGA Q5000 instrument from TA Instruments, Inc.

### Examples 1-8 and Comparative Examples A and B

Examples 1-8 are blends of DVBDO-95 or DVBDO-80 with D.E.R. 383 epoxy resin in the concentrations shown in Tables I and II, respectively; and Comparative Examples A and B do not contain the DVBDO-95 or DVBDO-80.

TABLE I
Blends of DVBDO-95 with D.E.R. 383 Epoxy Resin

| | DVBDO-95 | Viscosity | Crystallization Resistance |
|---|---|---|---|
| Example | wt. % | Pa-s | days |
| Comp. A | 0 | 5.2 | 4 |
| Ex. 1 | 5 | 2.9 | 11 |
| Ex. 2 | 10 | 1.8 | 15 |
| Ex. 3 | 15 | 1.2 | >188 |
| Ex. 4 | 20 | 0.7 | >188 |

TABLE II
Blends of DVBDO-80 with D.E.R. 383 Epoxy Resin

| | DVBDO-80 | Viscosity | Crystallization Resistance |
|---|---|---|---|
| Example | wt. % | Pa-s | days |
| Comp. B | 0 | 4.8 | 8 |
| Ex. 5 | 5 | 2.1 | 12 |
| Ex. 6 | 10 | 0.9 | 111 |
| Ex. 7 | 15 | 0.4 | >125 |
| Ex. 8 | 20 | 0.1 | >125 |

### Examples 9-11 and Comparative Examples C and D

Mixtures of DVBDO-95 (“Epoxy 1”) with 5, 10, 15, and 17 wt. % of ethyl styrene (ES) were prepared by adding the components to a jar and mixing at about 25° C. DVBDO-95 and portions of each mixture were then mixed with a stoichiometric amount of D.E.H. 20 epoxy hardener and cured using the following schedule: 60 minutes at 50° C., followed by 30 minutes each at 60° C., 90° C., 100° C., 110° C., 120° C., 150° C., 180° C., 210° C., and 240° C. to provide Examples 9-11; and Comparative Examples C and D, respectively. Table III shows the amounts of the components used and the appearance, weight loss after curing, specific gravity, and % specific gravity difference of the resulting thermosets.

TABLE III
Thermosets of DVBDO-95 (Epoxy 1) and D.E.H. 20 Having Ethyl Styrene

| | | | | | | | | Specific |
|---|---|---|---|---|---|---|---|---|
| | ES in | Wt. | Wt. DEH | | | Cure Wt. | Specific | Gravity |
| | Epoxy 1 | Epoxy/ES | 20 | Voids | | Loss | Gravity | Change |
| Example | wt. % | g | g | yes/no | Fig. | wt. % | g/cc | % |
| 9 | 0 | 275.05 | 71.33 | no | 1 | — | 1.2409 | — |
| 10 | 5 | 2.43 | 0.58 | no | 2 | 0.55 | 1.2272 | 1.10 |
| 11 | 10 | 2.44 | 0.56 | no | 3 | 1.03 | 1.2197 | 1.71 |
| Comp. C | 15 | 2.47 | 0.53 | yes | 4 | 2.42 | 1.2100 | 2.49 |
| Comp. D | 17 | 2.47 | 0.52 | yes | 5 | 4.08 | 1.2060 | 2.81 |

### Examples 12-14 and Comparative Examples E and F

A mixture of 10 wt. % of D.E.R. 383 epoxy resin in DVBDO-95 was prepared (Epoxy 2). Mixtures of Epoxy 2 with 5, 10, 15, and 17 wt. % of ethyl styrene (ES) were prepared as described above. Portions of each mixture were then mixed and cured with a stoichiometric amount of D.E.H. 20 epoxy hardener as described above to provide Examples 12-14; and Comparative Examples E and F, respectively. Table IV shows the amounts of the components used and the appearance, weight loss after curing, specific gravity, and % specific gravity difference of the resulting thermosets.

TABLE IV
Thermosets of 10 wt. % D.E.R. 383 in DVBDO-95
(Epoxy 2) and D.E.H. 20 Having Ethyl Styrene

| | | | | | | | | Specific |
|---|---|---|---|---|---|---|---|---|
| | ES in | Wt. | Wt. DEH | | | Cure Wt. | Specific | Gravity |
| | Epoxy 2 | Epoxy/ES | 20 | Voids | | Loss | Gravity | Change |
| Example | wt. % | g | g | yes/no | Fig. | wt. % | g/cc | % |
| 12 | 0 | 2.4190 | 0.5812 | no | 6 | 0.75 | 1.2314 | — |
| 13 | 5 | 2.4423 | 0.5580 | no | 7 | 1.63 | 1.2225 | 0.72 |
| 14 | 10 | 2.4674 | 0.5328 | no | 8 | 2.95 | 1.2143 | 1.39 |
| Comp. E | 15 | 2.4922 | 0.5088 | yes | 9 | 5.21 | 1.2035 | 2.27 |
| Comp. F | 17 | 2.5024 | 0.4990 | yes | 10 | 7.19 | 1.2025 | 2.35 |

### Examples 15-17 and Comparative Examples G and H

The mixtures of Examples 12-14 and Comparative Examples E and F were allowed to stand in a vial at 25° C. for 24 hours. The resulting cured materials were observed for appearance and morphology (Table V).

TABLE V
Appearance and Morphology of 10 wt. % D.E.R. 383 in DVBDO-95
(Epoxy 2) Having Ethyl Styrene (ES)

| Example | Appearance | Morphology | Fig. |
|---|---|---|---|
| 15 | clear | homogeneous | 11 |
| 16 | clear | homogenous | 12 |
| 17 | clear | homogenous | 13 |
| Comp. G | opaque | phase separated | 14 |
| Comp. H | opaque | phase separated | 15 |

### Examples 18-20 and Comparative Examples I-K

The epoxy components of Examples 9-11 and Comparative Examples C and D and ES were analyzed by TGA to determine values of T₋₅ as shown in Table VI.

TABLE VI
T₋₅ of DVBDO-95 (Epoxy 1), Ethyl Styrene (ES)
and Mixtures Thereof

| | ES in Epoxy 1 | T₋₅ |
|---|---|---|
| Example | wt. % | ° C. |
| 18 | 0 | 120 |
| 19 | 5 | 110 |
| 20 | 10 | 91 |
| Comp. I | 15 | 83 |
| Comp. J | 17 | 83 |
| Comp. K | 100 | 51 |

### Example 19 and Comparative Example L

Formulations of 10 wt. % D.E.R. 383 epoxy resin in DVBDO-95 and of D.E.R. 383 epoxy resin alone were fully cured with stoichiometric amounts of Ancamine DL-50, a modified methylenedianiline curing agent from Air Products, Inc. The properties of the resulting thermosets are shown in Table VII.

TABLE VII
Thermoset Properties

| Example | T_{g} (° C.) | Tensile Modulus (MPa) |
|---|---|---|
| 19 | 197 | 3885 |
| Comp. L | 188 | 3411 |

1. An epoxy resin composition comprising a divinylarene dioxide;
wherein the divinylarene dioxide has a concentration of less than about 15 weight percent styrenic impurities.

2. The epoxy resin composition of claim 1, having a temperature of 5 weight percent loss of greater than about 83° C.

3. An epoxy resin composition comprising a blend of (a) a divinylarene dioxide of claim 1; and (b) at least one epoxy resin different from the divinylarene dioxide of component (a).

4. The epoxy resin composition of claim 3, having a crystallization resistance of at least about 11 days.

5. A curable epoxy resin composition comprising (i) the epoxy resin blend composition of claim 3; and (ii) at least one curing agent.

6. The curable epoxy resin composition of claim 5, wherein upon using the epoxy resin composition, the specific gravity change of the resulting cured product after curing is less than about 2.2 percent.

7. The composition of claim 1, 3 or 5, wherein the divinylarene dioxide is divinylbenzene dioxide.

8. The composition of claim 1, 3 or 5, wherein the concentration of said divinylarene dioxide ranges from about 1 weight percent to about 99 weight percent.

9. The composition of claim 3, wherein component (b), the at least one epoxy resin different from the divinylarene dioxide of component (a), comprises a reaction product of a polyfunctional alcohol, phenol, cycloaliphatic carboxylic acid, aromatic amine, or aminophenols with epichlorohydrin; or mixtures thereof.

10. The composition of claim 3 or 5, wherein the concentration of the at least one epoxy resin different from the divinylarene dioxide of component (a) ranges from about 1 weight percent to about 99 weight percent.

11. The composition of claim 5, wherein the curing agent comprises anhydrides, carboxylic acids, amine compounds, or mixtures thereof.

12. The composition of claim 5, wherein the concentration of said curing agent ranges from about 0.1 weight percent to about 90 weight percent.

13. The composition of claim 5, including a curing catalyst; wherein the concentration of the curing catalyst ranges from about 0.1 weight percent to about 20 weight percent.

14. The composition of claim 13, wherein the curing catalyst comprises catalyst compounds containing amine, phosphine, heterocyclic nitrogen, ammonium, phosphonium, arsonium, sulfonium moieties; or mixtures thereof.

15. A process for preparing an epoxy resin composition comprising blending (a) a divinylarene dioxide of claim 1; and (b) at least one epoxy resin different from the divinylarene dioxide of component (a).

16. A process for preparing a curable epoxy resin composition comprising admixing (i) the epoxy resin blend composition of claim 3; and (ii) at least one curing agent.
